(19) United States
(12) Patent Application Publication
(10) Pub. No.: US 2007/0224940 A1
(43) Pub. Date: Sep. 27, 2007

(54) Reducing electromagnetic interferences

(75) Inventors: Ilkka Pankinaho, Paimio (FI); Risto Vaisanen, Salo (FI); Kaj Saarinen, Tokyo (JP); Juha H-P Nurmi, Salo (FI)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/711,483

(22) Filed: Feb. 26, 2007

(30) Foreign Application Priority Data
Feb. 28, 2006 (IB) PCT/IB06/50618

(51) Int. Cl. H04B 17/00

(52) U.S. Cl. 455/62

(57) ABSTRACT

An electronic device 300 comprises a processing component 330 for reducing electromagnetic interferences. The processing component 330 is adapted to determine an activity status of at least one first component 311-315 operating in at least one known frequency range. The processing component 330 is further adapted to adjust an operating frequency of an active second component 321-322 depending on the determined activity status of the at least one first component 311-315. The invention relates equally to a chipset 330, to a method, to a software code 331 and to a software program product realizing the functions of the processing component 330.

### FIELD OF THE INVENTION

The invention relates to an electronic device reducing electromagnetic interferences. The invention relates equally to a chipset, to a method, to a software program code and to a software program product for reducing electromagnetic interferences.

### BACKGROUND OF THE INVENTION

An electronic device may comprise a multitude of components for offering different functions. Some of these components may be a source of electromagnetic interferences (EMI), while other components of the same device may be sensitive to electromagnetic interferences.

A mobile terminal, for instance, may comprise on the one hand peripheral components, like a display and a camera, etc. Such components typically use a clock oscillator for clocking the component internal operations. As an unintentional side effect, the clock oscillator generates radio frequency signals, called spurious emissions, in particular at the operating frequency and its harmonics.

A mobile terminal may comprise on the other hand several radio system components, like a global system for mobile communications (GSM) component, a wideband code division multiple access (WCDMA) component, a Bluetooth™ (BT) component, a wireless local area network (WLAN) component or a global positioning system (GPS) component. Such radio systems are becoming more and more sensitive to spurious emissions. In addition, the allowed frequency ranges for active radio system components are reduced.

The disturbances caused by a clock oscillator of the peripheral components may be coupled in for instance by radiation to a reception (RX) or transmission (TX) band or to the synthesizers of the radio systems. In near fields, it may be coupled in as well in a conductive way, for instance via the commonly used operating voltage or groundings.

Further, a disturbance may be coupled in via other signals, like voltage controlled oscillator (VCO) signals, temperature controlled crystal oscillator (TCXO) signals, signals on base band (BB) digital buses, synthesizer frequencies, etc. That is, disturbance can travel a part of a distance by conduction and a part of a distance by radiation. For example, the harmonic disturbance of a clock signal from a display could connect to a VCO. This could happen because the resonance circuit of the VCO acts as an antenna. In the VCO, the disturbance and the VCO's own signal can combine and produce a different disturbance that is the sum or the difference of the original frequencies. This new disturbance can then reach a receiver or transmitter mixer in the same way as a normal VCO signal. In this example, the disturbance first travels by radiation to the VCO, and from there after combining with the VCO-signal it continues by conducting. While such a route is very common, the source of disturbance could also be some other component than a display. In general, the routes can be very complex and any long conducting wire in a printed wiring board (PWB) can act as an antenna.

FIG. 1 is a diagram illustrating the problem for some components of a mobile terminal. FIG. 1 presents an LCD module 10 and an ASIC 11 of a processor that is controlling the display. The LCD module 10 and the ASIC 11 are connected to each other by cables 14. The ASIC 11 generates a pixel clock signal of 6 MHz, which is provided via an RGB I/F block 12 of the ASIC 11 and the cables 14 to the LCD module 10. The pixel clock defines the pixel sampling rate of the LCD module 10 and is further running as a base clock for all display internal operations.

The pixel clock signal causes spurious emissions at the clock frequency of 6 MHz and at its harmonics. The spurious emissions are represented by a flash sign 15.

The caused EMI might block for example some GSM radio channels. Other active radio systems, like the WLAN, might not be disturbed by the specific spurious emission frequencies.

If problems in electromagnetic compatibility (EMC) are discovered during research and development, or even at a later phase, then changes to the involved components or to the surroundings are needed. This process is time-consuming and can typically only decrease the severity of the problem, but not resolve it completely. With an increasing number of components, it might be particularly difficult and time consuming to find an allowed frequency band for EMI generating components. Such a search may require physical changes of the mechanics or driving electronics, and the possible use cases could even be limited.

There exist some approaches for solving the problem on a more general basis.

A first approach is illustrated in FIG. 2. FIG. 2 presents the same components 10, 11, 12, 14 of a mobile terminal as FIG. 1. In addition, however, an EMC shielding 20 for the LCD module 10 and an EMC shielding 21 for the cables 14 connecting the ASIC 11 with the LCD module 10 is provided. As a result of the shielding 21, the amount of the spurious emissions is decreased, as indicated by a smaller flash sign 25. The reduction may be sufficient to prevent a blocking of the GSM channels. Such a shielding 20, 21, however, increases the costs of the manufacturing process.

In US patent application 2003/0169838 A1 it is further mentioned that a reference oscillator may be frequency modulated to provide a spread energy spectrum. It is moreover proposed in this document to include an adjustable delay generator between a phase locked loop and a clock buffer, in order to obtain a phase modulation which allows the energy of a clock signal to be spread over a wider range of frequencies in a relatively short time interval. A phase modulation of a clock signal, however, might render the use of the clock signal more complex.

### SUMMARY OF THE INVENTION

It is an object of the invention to enable an alternative reduction of disturbances by electromagnetic interferences. It is in particular an object of the invention to enable a reduction of disturbances, which are caused and experienced within a single device.

An electronic device is proposed, which comprises a processing component for reducing electromagnetic interferences. The processing component is adapted to determine an activity status of at least one first component operating in at least one known frequency range. The processing component is further adapted to adjust an operating frequency of an active second component depending on the determined activity status of the at least one first component.

The processing component can be realized in hardware and/or in software. It may comprise for instance a processor executing a software program code realizing the required functions. Alternatively, it may comprise for instance at least one chip, in which the functions are realized by a hard-wired circuit.

Either of the at least one first component and the at least one second component may be integrated in particular, although not necessarily, in the electronic device as well. Alternatively, at least one of the components could be for instance a part of an accessory device for the electronic device.

Moreover, a chipset is proposed, which comprises at least one chip for reducing electromagnetic interferences. The at least one chip is adapted to determine an activity status of at least one first component operating in at least one known frequency range. The at least one chip is further adapted to adjust an operating frequency of an active second component depending on the determined activity status of the at least one first component.

Moreover, a method for reducing electromagnetic interferences is proposed. The method comprises determining an activity status of at least one first component operating in at least one known frequency range. The method further comprises adjusting an operating frequency of an active second component depending on the determined activity status of the at least one first component.

Moreover, a software program code for reducing electromagnetic interferences, is proposed, which realizes the proposed method when being executed by a processor.

Finally, a software program product is proposed, in which such a software program code is stored. The software program product can be for instance a separate memory device or a memory component integrated into a device.

The invention proceeds from the consideration that a component generating electromagnetic interferences may have several allowed operating frequencies, making it possible to assign the operating frequency that is to be used dynamically. It is therefore proposed that the operating frequencies of certain components and thus the frequencies of the electromagnetic interferences generated by these components are changed into allowed ranges depending on a respective situation. A respective situation is defined at least by the activity status of components operating in known frequency ranges that are to be protected from disturbances. It is to be noted that the term activity status is to be understood in a comprehensive sense. That is, it could indicate simply whether or not a component is active, but it could also indicate a specific type of activity. The activity status could indicate for example which channel or which frequency a component is using.

It is an advantage of the invention that it provides a simple and flexible possibility of reducing electromagnetic interferences in selected frequency bands. EMI shieldings are not required, and neither frequency nor phase modulations have to be taken into account in the operation of the components causing the electromagnetic interferences.

The invention is of a particular advantage for the case that a plurality of first components may be disturbed by one or more second components. In this case, the operating frequency of the active second components may be adjusted anew with each change of the activity status of any of the first components.

The operating frequency of a component may cause EMI at the operating frequency itself and at its harmonics. In one embodiment of the invention, the operating frequency of an active second component may thus be adjusted specifically such that neither the adjusted operating frequency nor one of its harmonics lie within the at least one known frequency range in which an active first component is adapted to operate.

The at least one first component can comprise any component that may be sensitive to electromagnetic interferences caused by another component. This is usually the case with radio system components. The at least one first component may thus comprise for instance a Bluetooth™ component, a mobile communication system component—like a GSM or a WCDMA system component—, a WLAN component and/or a satellite based positioning system component—like a GPS, a GLONASS or a Galileo component—, etc.

The at least one second component can comprise any component that runs the risk of disturbing other components by electromagnetic interferences. They may be for instance non-radio system components using a clock signal for synchronizing their operating frequency. Such a clock signal may be generated within the respective second component or be provided by an external clock generator to the respective second component. The at least one second component may comprise for example a display and/or a camera module, etc.

In a simple approach, the adjustment depends only on the activity status of at least one first component. For example, a phone may be programmed to change automatically its currently used clock frequencies, when those clock frequencies are known to potentially disturb some other component.

In another example, additional conditions are evaluated for the decision on an adjustment. For example, if the first component is a receiver, the clock frequency of a possibly disturbing second component, like a display, may be changed only, if the receiver receives a signal of low quality. If the quality of the received signal improves, the disturbing component may further return to the original clock frequency.

If the at least one second component comprises a display, the adjustment of the operating frequency may affect the pixel rate of the display. In this case, the processing component may further be adapted to adjust blanking settings for the display in accordance with the operating frequency adjusted for the display component such that the display refresh mode remains the same without affecting the visual appearance or the operation. Blanking settings define in a sequence of pixels when to start scanning the next line of a frame or a picture and when to start scanning the next frame or picture.

It is to be understood that the presented embodiments can be implemented in each of the proposed electronic device, the proposed chipset, the proposed method, the proposed software program code and the proposed software program product.

The proposed electronic device can be a stationary device or a mobile device, like a mobile phone.

### BRIEF DESCRIPTION OF THE FIGURES

Other objects and features of the present invention will become apparent from the following detailed description considered in conjunction with the accompanying drawings.

FIG. 1 is a schematic diagram illustrating the EMI problem in a conventional device;

FIG. 2 is a schematic diagram illustrating a conventional solution to the EMI problem in FIG. 1;

FIG. 3 is a schematic block diagram of an electronic device according to an embodiment of the invention;

FIG. 4 is a schematic diagram illustrating selected components of the device of FIG. 3; and

FIG. 5 is a flow chart illustrating an operation in the device of FIG. 3.

### DETAILED DESCRIPTION OF THE INVENTION

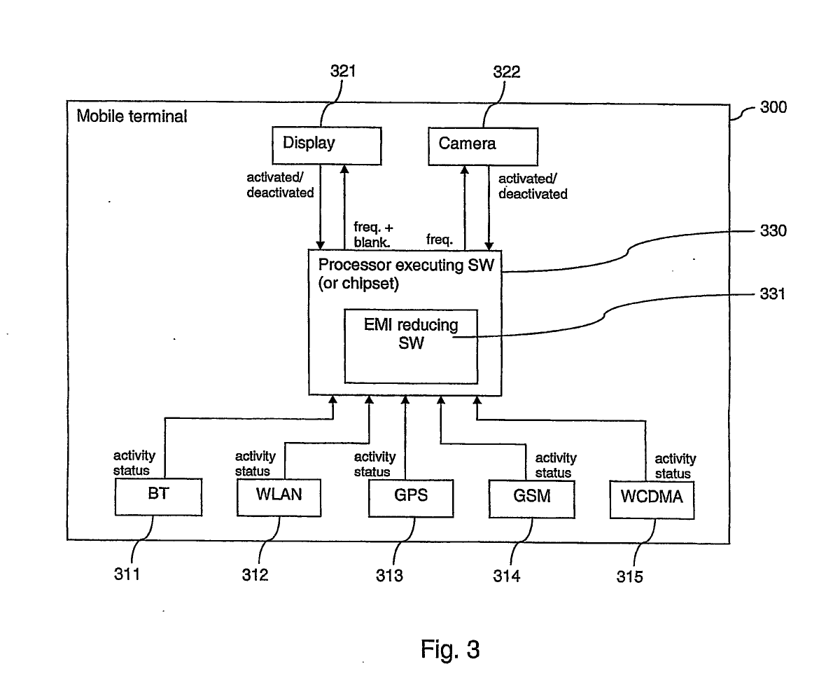

FIG. 3 is a schematic block diagram of an exemplary electronic device, which enables a protection of components from electromagnetic interferences in accordance with an embodiment of the invention.

The electronic device is a mobile terminal 300. It comprises a first group of components for a respective radio system, including a Bluetooth™ (BT) component 311, a WLAN component 312, a GPS component 313, a GSM component 314 and a WCDMA component 315. All components of the first group operate in known frequency ranges, including for example a respective baseband frequency range, a respective intermediate frequency range and a respective radio frequency range. Further, the mobile terminal 300 comprises a second group of components including a display 321 and a camera module 322. The second group of components makes use of a respective clock signal for synchronizing the component internal operations. The clock signals are provided by a respective clock signal generator. The frequency of the respective clock signal is the operating frequency of the components 321, 322 and lies in the baseband ranges of the radio systems. The operating frequency is variable to a certain extent and can be adjusted via a control input of the respective clock signal generator.

The mobile terminal 300 comprises in addition a processor 330 adapted to execute software program code. The implemented software program code comprises a software program code (SW) 331 for reducing electromagnetic interferences. It is to be understood that instead of the processor 330, a chipset realizing corresponding functions could be used.

The processor 330 is connected to all components 311-315 of the first group for receiving control information and to all components 321, 322 of the second group for exchanging control information.

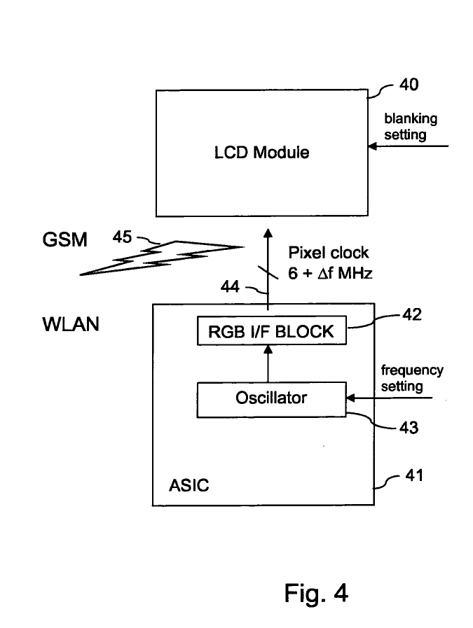

Some details of the display 321—as an exemplary component of the second group—are depicted in FIG. 4. The display 321 comprises an LCD module 40 with a Video Streaming Screen Interface (ViSSI) and an ASIC 41 with an RGB I/F block 42 and an oscillator 43. The ASIC 41 is connected to the LCD module 40 by cables 44. The oscillator 43 is a clock signal generator, which generates a pixel clock signal at a default rate of 6 MHz. The default rate can be varied via a control input by means of a control signal indicating the desired variation from the default rate. The pixel clock signal is provided via the RGB I/F block 42 and the cables 44 to the LCD module 40, where it is used as a base clock signal for all display internal operations. The LCD module 40 comprises in addition a control input for a blanking settings control signal.

It is to be understood that the display 321 could also be realized in various different manners, as long as its operating frequency can be varied. In one alternative, an LCD module could comprise a controllable internal oscillator.

The other components 322 of the second group may comprise a corresponding adjustable clock signal generator.

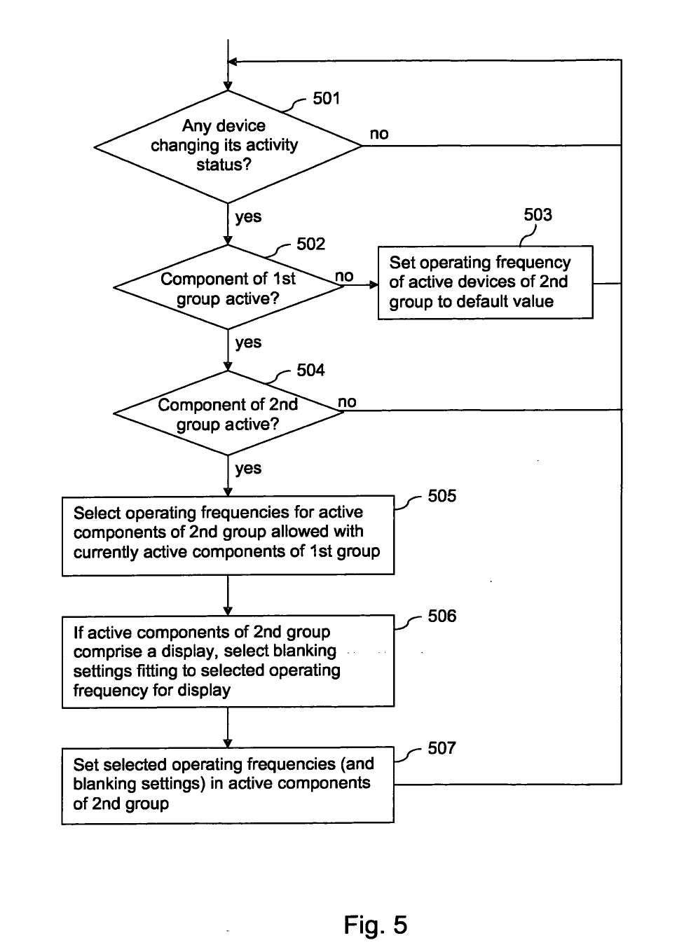

The operation of the mobile terminal 300 in accordance with the invention will now be described in more detail with reference to the flow chart of FIG. 5. It is to be understood that all operations that are indicated to be performed by the processor 330 are realized by the processor 330 by executing the software program code 331.

Any component 311-315, 321, 322 changing its activity status provides a corresponding indication to the processor 330. That is, the component informs the processor 330 when it changes from inactive to active as well as when it changes from active to inactive. Further, the components 311-315 of the first group may indicate a change of their activity status in case they change the frequency range in which they are operating.

The processor 330 continuously monitors whether it receives such an indication (step 501).

If a change of the activity status of any of the components is detected, the processor 330 determines whether at least one of the components 311-315 of the first group is active (step 502). If this is not the case, the processor 330 may set or reset the operating frequency of all active components 321, 322 of the second group to a respective default operating frequency (step 503). Then the processor 330 continues monitoring whether it receives an indication of an activity status change (step 501).

If it has been determined in step 502 that at least one of the components 311-315 of the first group is active, the processor 330 further determines whether at least one of the components 321, 322 of the second group is active too (step 504). If this is not the case, the processor 330 continues monitoring whether it receives an indication of an activity status change (step 501).

If it has been determined in step 504 that at least one of the components 321, 322 of the second group is active, the processor 330 selects suitable operating frequencies for all active components 321, 322 of the second group (step 505). A suitable operating frequency is a frequency that is expected not to cause any spurious emissions in the frequency ranges currently used by the active components 311-315 of the first group. Thus, neither the operating frequency nor its harmonics should fall into a baseband frequency range, an intermediate frequency range or a radio frequency range currently employed by any of the active components 311-315 of the first group.

The selection can be carried out for instance by means of a predefined mapping table listing suitable operating frequencies—or suitable deviations Δf from default operating frequencies—for all possible combinations of frequency ranges that may be used by the active components 311-315 of the first group and active components 321, 322 of the second group. Other selection approaches are possible as well. The processor 330 could for example consider one possible operating frequency after the other for a respective active component of the second group, each time calculating all relevant harmonics and comparing the operating frequency and the harmonics with all frequency ranges currently required by the active components of the first group. Once an operating frequency has been found that does not result in any collisions, this operating frequency may be selected and the selection process be stopped for the component of the second group.

If the active components 321, 322 of the second group comprise the display 321, the processor 330 selects in addition blanking settings for the display 321 that are suitable for the selected operating frequency (step 506).

Finally, the processor 330 adjusts the operating frequency of the active components 321, 322 of the second group to the selected operating frequencies via a control input of the respective oscillator (step 507). Each component 321, 322 of the second group may have a default operating frequency and the processor 330 may adjust the operating frequency by forwarding the required deviation from this default operating frequency to the component 321, 322.

In the case of an active display 321 as presented in FIG. 4, for example, the oscillator 43 provides a pixel clock signal having a default frequency of 6 MHz. The processor 330 may send the required amount of deviation Δf MHz to the ASIC 41, where the pixel clock signal provided by the oscillator 43 is changed accordingly to 6 MHz+Δf MHz.

If the active components of the second group comprise the display 321, the processor 330 adjusts in addition the blanking settings of the display 321 to the selected values by informing the display 321 accordingly. In the case of a display 321 as presented in FIG. 4, for example, the processor 330 may provide the required settings to the control input of the LCD module 40. As a result, the change of the pixel rate due to the adjusted pixel clock signal does not cause visible effects on the screen.

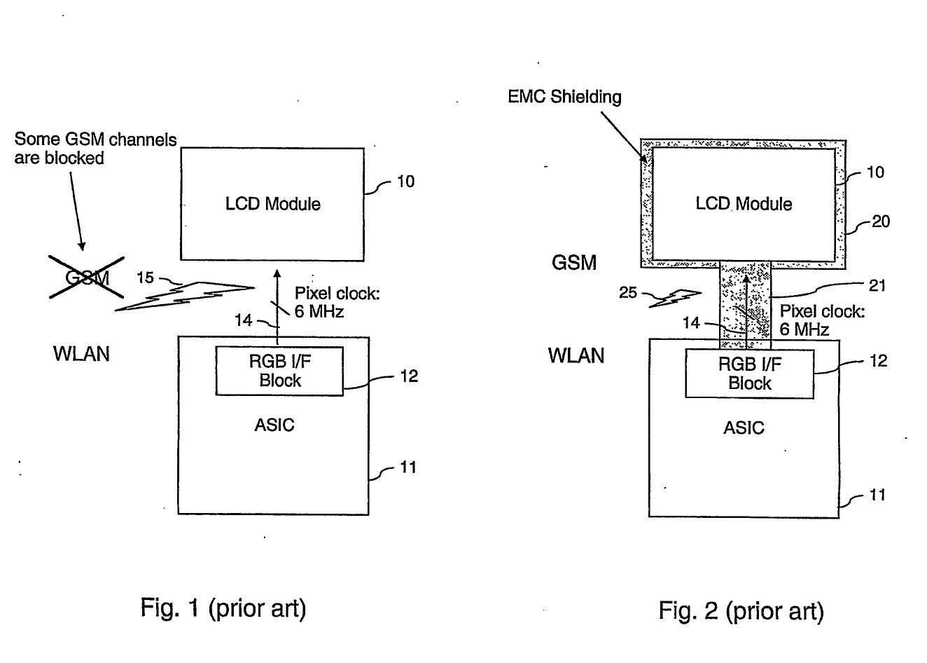

With the presented method, the amount of the caused spurious emissions is not reduced. Thus, the flash symbol 45 in FIG. 4 has the same size as in FIG. 1. However, the spurious emissions are shifted to other frequencies, which do not lie in any frequency range employed by one of the currently active radio systems. As a result, the active components of the first group, for example the GSM component 314 and the WLAN component 312, are not disturbed any more by the active components of the second group, for example the display 321.

The newly set operating frequencies of the components 221, 222 of the second group might result in electromagnetic interferences in the forbidden frequency band of one of the radio system components 311-315 becoming active at a later point of time. As soon as any of the involved components 311-315, 321, 322 changes its activity status, the operating frequencies of the components 221, 222 of the second group are therefore updated again with steps 501 to 507. Thus, a continuing swapping is performed to enable the simultaneous operation of various combinations of all components 311-315, 321, 322.

It is to be noted that the described embodiment constitutes only one of a variety of possible embodiments of the invention.

1. Electronic device (300) comprising a processing component (330) for reducing electromagnetic interferences,
said processing component (330) being adapted to determine an activity status of at least one first component (311-315) operating in at least one known frequency range, and
said processing component (330) being adapted to adjust an operating frequency of an active second component (321-322) depending on said determined activity status of said at least one first component (311-315).

2. Electronic device (300) according to claim 1, further comprising at least one of said at least one first component (311-315) and said at least one second component (321-322).

3. Electronic device (300) according to claim 1, wherein said processing component (330) is adapted to adjust said operating frequency of an active second component (321-322) such that neither said adjusted operating frequency nor one of its harmonics lie within said at least one known frequency range in which an active first component (311-315) is adapted to operate.

4. Electronic device (300) according to claim 1, wherein said at least one first component (311-315) comprises at least one radio system component.

5. Electronic device (300) according to claim 1, wherein said at least one first component (311-315) comprises at least one of
a Bluetooth™ component (311);
a mobile communication system component (313-314);
a wireless local area network component (312); and
a satellite based positioning system component (315).

6. Electronic device (300) according to claim 1, wherein said at least one second component (321-322) comprises at least one non-radio system component.

7. Electronic device (300) according to claim 1, wherein said at least one second component (321-322) comprises at least one of
a display (321); and
a camera module (322).

8. Electronic device (300) according to claim 1, wherein said at least one second component (321-322) comprises at least a display (321), wherein an adjustment of an operating frequency of said display (321) affects a pixel rate of said display (321), and wherein said processing component (330) is further adapted to adjust blanking settings for said display (321) in accordance with an operating frequency adjusted for said display (321).

9. Chipset (330) comprising at least one chip for reducing electromagnetic interferences, wherein said at least one chip is adapted to determine an activity status of at least one first component (311-315) operating in at least one known frequency range, and wherein said at least one chip is adapted to adjust an operating frequency of an active second component (321-322) depending on said determined activity status of said at least one first component (311-315).

10. Method for reducing electromagnetic interferences, said method comprising:
determining an activity status of at least one first component (311-315) operating in at least one known frequency range; and
adjusting an operating frequency of an active second component (321-322) depending on said determined activity status of said at least one first component (311-315).

11. A software program code (331) for reducing electromagnetic interferences, wherein, said software program code (331) realizing the following steps when being executed by a processor (330):
determining an activity status of at least one first component (311-315) operating in at least one known frequency range; and
adjusting an operating frequency of an active second component (321-322) depending on said determined activity status of said at least one first component (311-315).

12. A software program product (330) in which a software code (331) according to claim 11 is stored.
